(19) United States
(12) Patent Application Publication
(10) Pub. No.: US 2005/0193849 A1
(43) Pub. Date: Sep. 8, 2005

(54) Rack-and-pinion steering system

(76) Inventors: Jurgen Osterlanger, Emskirchen (DE); Alexander Zernickel, Herzogenaurach (DE); Manfred Kraus, Herzogenaurach (DE); Stefan Willared, Erlangen (DE)

Correspondence Address: OSTROLENK FABER GERB & SOFFEN, 1180 AVENUE OF THE AMERICAS, NEW YORK, NY, 100368403, US

(21) Appl. No.: 11/074,216

(22) Filed: Mar. 7, 2005

(30) Foreign Application Priority Data
Mar. 5, 2004 (DE) 10 2004 010 821.8

(51) Int. Cl. F16H 35/00

(52) U.S. Cl. 74/388 PS; 74/491

(57) ABSTRACT

A gear rack for a rack-and-pinion steering system for a motor vehicle. The rack having a bearing surface including a recess within a circular gear rack. A guide roller, which is borne via a needle bearing, has corresponding bearing surfaces, resting on the bearing surfaces of the rack.

### FIELD OF THE INVENTION

The invention relates to a rack-and-pinion steering system for a motor vehicle, having a steering gear housing, in which a gear rack is mounted such that it can move longitudinally, and having a pinion, which meshes with the gear rack, and a pressure part, which is arranged on a side of the gear rack opposite an engagement side with the pinion. The pressure part is prestressed with the aid of a spring against the gear rack. The pressure part has inside it a rotatable guide roller which is matched to the contour of the gear rack and has a bearing surface against which the gear rack bears with a corresponding bearing surface. The bearing surfaces are arranged relative to each other in such a way that the gear rack is prevented from being twisted in the peripheral direction.

### BACKGROUND OF THE INVENTION

Rack-and-pinion steering systems of this type have long been known from the prior art. In these steering systems, the gear rack is guided displaceably in the longitudinal direction in a steering gear housing. A pinion, rotatably mounted in the steering gear housing, engages in the toothing of the gear rack. Turning of the steering column connected in a rotationally secure manner to the pinion brings about the lateral displacement of the gear rack, which, in turn, via tie rods and steering knuckles, causes the steered wheels of the motor vehicle to swivel. The engagement of the pinion in the gear rack is kept free from backlash, in that a pressure part, which bears against the gear rack opposite the pinion, forces the gear rack against the pinion in a prestressed manner. In this context, the pressure part must, on the one hand, be able to transmit the necessary pressure force and, on the other hand, offer a bearing face which, during movement of the gear rack, produces no significant friction forces and no substantial wear on the pressure part. If the steering force applied by the driver via the pinion is amplified by a ball screw, then, as a result of the torque transmission, the gear rack will attempt to twist over its axial length in the peripheral direction. An attempt is made to prevent this by arranging the bearing surfaces of the guide roller and gear rack in such a way relative to each other that they stop the gear rack from being twisted.

A rack-and-pinion steering system of this type is known from DE 82 03 943 U. As shown by FIG. 5 of this prior publication, the gear rack has two bearing surfaces, which are inclined symmetrically towards the toothing plane. The rack-and-pinion steering system further includes a guide roller, which is arranged in a pressure part and likewise has two bearing surfaces. The bearing surfaces of the gear rack are produced by the removal of material by machine-cutting from the round gear rack in its original state. The bearing surfaces of the guide roller are formed by two outer rings of a ball bearing, which are arranged in the pressure part and which have contacting surfaces which form the bearing surfaces. The bearing surfaces are likewise symmetrically inclined in relation to the toothing plane. It is obvious that such positioning of the bearing surfaces of the gear rack and guide roller prevents the gear rack from being twisted in the peripheral direction.

One drawback of a rack-and-pinion steering system such as this is the complex design of the bearing surfaces of the gear rack and guide roller. On the one hand, the machining of the gear rack is complex and hence expensive, since a considerable amount of material has to be removed. On the other hand, the pressure part is of very complicated construction and hence also expensive. For instance, two ball bearings have to be accommodated in the pressure part with a bolt each, which places high demands on the assembly and requires additional construction space.

### SUMMARY OF THE INVENTION

Starting from the drawbacks of the known prior art, the object of the invention is therefore to provide a substantially simplified rack-and-pinion steering system with a pressure part, which is simple to produce and can reliably absorb torques, radial and axial forces, while offering high load-bearing capacity.

According to the invention, this object is achieved by the fact that the bearing surface is configured as at least one recess within the gear rack. Within the invention, this should be taken to mean that in the lower part of the gear rack, i.e. in the region of the guide roller, the circle perimeter or periphery thereof is only slightly interrupted.

This offers the advantage that the recess serving as a bearing surface can be incorporated into the gear rack by a simple machine-cutting process, for example by milling. The round cross-sectional profile of the gear rack is thereby substantially preserved. It is therefore no longer necessary, as in the prior art, to remove loads of material by machine-cutting in order to produce the bearing surfaces.

Further advantageous designs of the invention are next described.

For instance, the bearing surface of the gear rack is intended to be semicircular or V-shaped. These two embodiments are on a par and, because of their uncomplicated geometric cross-sectional shapes, they can also be easily introduced into the gear rack.

A further feature of the invention provides for the guide roller to be mounted in the pressure part via a needle bearing, which is held by a bearing shaft, such that the bearing can rotate. Needle bearings are standardized commercially available parts which can be obtained at low cost in widely differing dimensions. Furthermore, they are able to absorb high radial forces and ensure that the guide roller does not produce any noise.

Axial forces which occur can reliably be absorbed. For example, the guide roller may be surrounded on both sides by in each case one thrust washer in the axial direction or the guide roller may be surrounded on both sides by in each case one axial bearing in the axial direction.

As a further feature of the invention, the pressure part is intended to be produced from a plastic, which can be manufactured at low cost in different design variants by injection molding. A pressure part design such as this has additional damping characteristics, which have a positive effect on steering convenience.

In order to make a pressure part such as this that is comprised of plastic that is more robust, particularly at high temperatures, the pressure part may be held by a metallic sleeve, at least over a portion of its envelope surface.

Finally, the pressure part has a projection which overhangs the metallic sleeve in the radial direction. This projection also has a noise-damping effect since a contact composed of a low-friction plastic is provided in the immediate vicinity of the steel sleeve, which is held captive.

The invention is explained in greater detail below with reference to the following illustrative embodiments.

Other features and advantages of the present invention will become apparent from the following description of the invention which refers to the accompanying drawings.

### BRIEF DESCRIPTION OF THE DRAWINGS

FIGS. 1 and 2 show a longitudinal section through a pressure part, designed according to the invention, with gear rack, and

FIG. 3 shows a longitudinal section through a pressure part with a gear rack according to the prior art.

### DETAILED DESCRIPTION OF EMBODIMENTS OF THE INVENTION

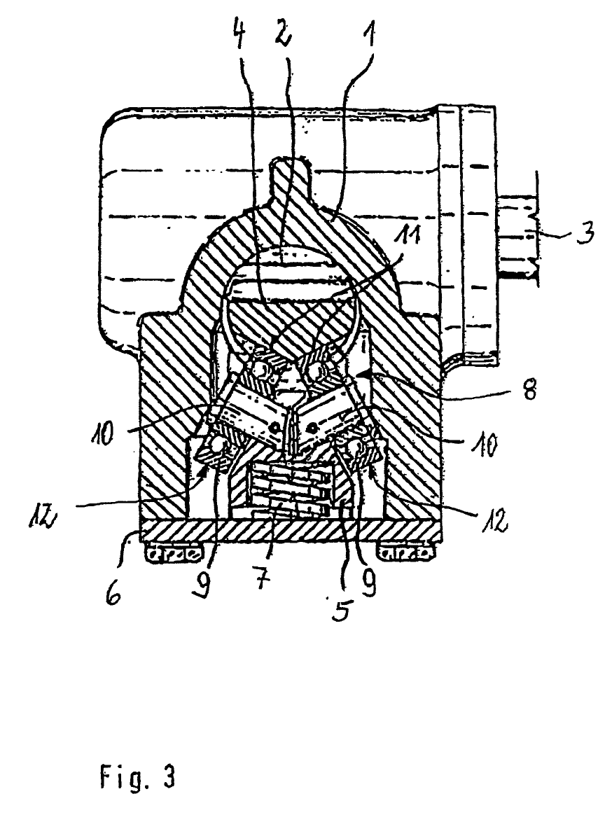

In order to describe the overall context, reference should firstly be made to the prior art according to FIG. 3. This shows a housing 1, in which a pinion 2, which merges into a steering spindle 3, is mounted. The toothing of a gear rack 4, which runs transversely to the pinion 2, engages in the toothing of the pinion 2. On the side of the gear rack 4 opposite the engagement side of the pinion 2 with the gear rack 4 there is a pressure part 5, which substantially supports the force transmitted by the pinion 2 to the gear rack 4. The pressure part 5 is accommodated in a retaining hole (not labeled) in the housing 1, and is preloaded in the direction of the gear rack 4 by a spring 7 arranged between the pressure part 5 and a cover 6 rigidly connected to the housing 1.

Accommodated in the pressure part 5 there is a guide roller 8, comprising two roller bearings 9, which are configured as deep-groove ball bearings and are held on a respective bearing shaft 10. The bearing shafts 10 and hence the roller bearings 9 are arranged at a specific angle to the toothing plane, so that the obliquely set outer rings of the roller bearings 9 bear with their bearing surfaces 12 against the bearing surfaces (denoted by 11) of the gear rack 4. It is obvious that the gear rack 4 cannot move in the peripheral direction should a torque be applied, for example by a ball screw.

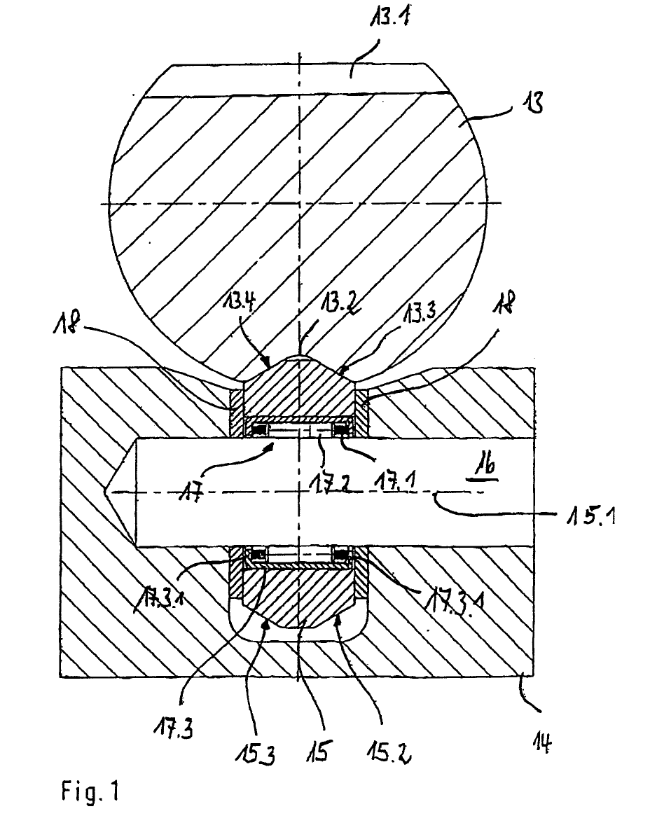

In FIG. 1, an arrangement of an inventive pressure part 14 and a gear rack 13 is shown. The gear rack 13, on its side facing away from the pressure part 14, is provided according to the prior art with toothing 13.1, in which a pinion (not shown) engages. On its side opposite the toothing 13.1, the gear rack 13 has a recess 13.2, which, in the illustrated embodiment, is V-shaped, forming two bearing surfaces 13.3, 13.4, which are inclined symmetrically to the toothing 13.1. A guide roller 15 is held on a bearing shaft 16 in the pressure part 14 via a needle bearing 17 such that it can rotate. The guide roller 5 is in the form of a rotationally symmetrical body, which likewise has supporting surfaces 15.2, 15.3 which are inclined with respect to one another, symmetrically with respect to its rotation axis 15.1. In other words, the guide roller 15 has a longitudinal section generally in the form of a house, with a roof engaging in the V-shaped recess 13.2 in the gear rack 13. The axial needle bearing 17 comprises bearing needles 17.2 which are guided in a cage 17.1 and are held by a needle sleeve 17.3, which is provided with edges 17.3.1 which point radially inwards. Finally, the needle bearing 17 also has in each case one thrust washer 18, which washers are arranged on the right-hand and left-hand sides and are used to support axial forces.

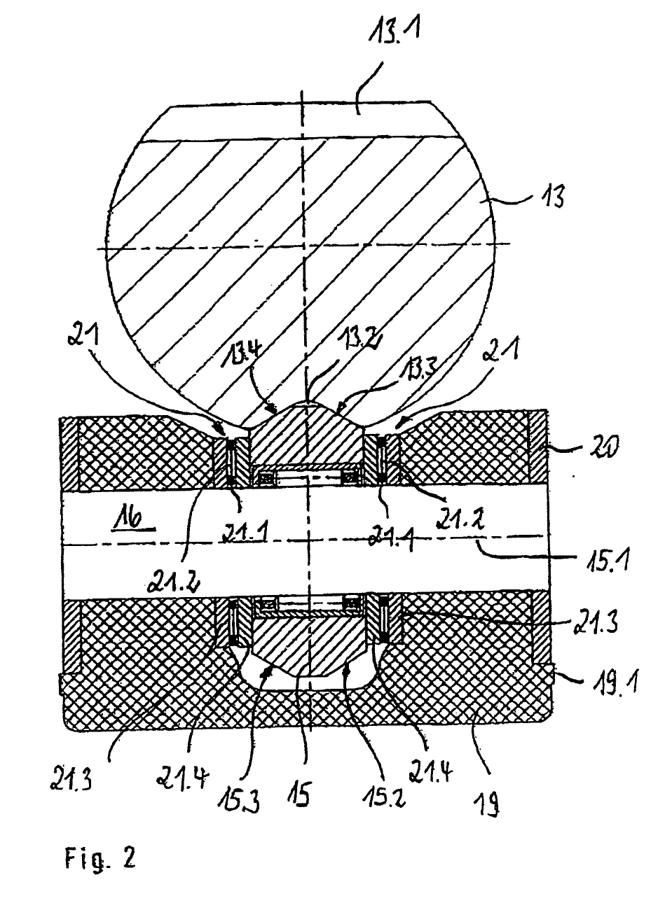

The pressure part 19 shown in FIG. 2 differs from that in FIG. 1 by being produced from a plastic. For better dimensional stability, the pressure part 19 is surrounded by a metallic sleeve 20 over at least a part of its envelope surface, with the plastic body having a projection 19.1 which points radially outwards and on which the sleeve 20 is fitted. A further significant difference is that the guide roller 15 is supported in each case by one axial bearing 21 in order to absorb axial forces that occur. The bearing needles 21.2 of the axial bearing 21 are guided in a cage 21.1 and roll between the two associated running disks 21.3, 21.4. The running disk 21.3 is arranged fixed in the plastic body of the pressure part 19, and the associated other running disk 21.4 rotating with the guide roller 15.

A unit comprising pressure part 14, 19 and a gear rack 13 is illustrated in both Figures, and is distinguished by the following advantages:
low-cost production and assembly
low friction losses and low running noise
reliable absorption of axial and radial forces and of torques acting on them
high load-bearing capacity.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A rack-and-pinion steering system for a motor vehicle, comprising:
a steering gear housing, a gear rack mounted in the gear housing such that it can move longitudinally, the gear rack having an engagement side and an opposite side, the gear rack having a contour;
a pinion which meshes with the gear rack on the engagement side;
a pressure part arranged on the side of the gear rack opposite the engagement side with the pinion;
a spring prestressing the pressure part against the gear rack;
a rotatable guide roller inside the pressure part and matched to the contour of the gear rack, the guide roller having a bearing surface against which the gear rack bears with a corresponding bearing surface of the gear rack;
the bearing surfaces being arranged relative to each other in such a way that the gear rack is prevented from being twisted in a peripheral direction; and
the bearing surface of the gear rack has at least one recess situated within the gear rack.

2. A rack-and-pinion steering system according to claim 1, wherein the recess in the gear rack is semicircular.

3. A rack-and-pinion steering system according to claim 1, wherein the recess in the gear rack is V-shaped.

4. A rack-and-pinion steering system according to claim 1, further comprising a needle bearing for mounting the guide roller in the pressure part, a bearing shaft holding the needle bearing, such that the bearing can rotate.

5. A rack-and-pinion steering system according to claim 4, further comprising a respective thrust washer surrounding the guide roller in the axial direction on both sides.

6. A rack-and-pinion steering system according to claim 4, further comprising a respective axial bearing surrounding the guide roller in the axial direction on both sides.

7. A rack-and-pinion steering system according to claim 1, wherein the pressure part is produced from a plastic.

8. A rack-and-pinion steering system according to claim 7, further comprising a metallic sleeve holding the pressure part at least over a part of an envelope surface of the pressure part.

9. A rack-and-pinion steering system according to claim 8, wherein the pressure part has a projection which overhangs the metallic sleeve in the radial direction.
